(19) United States
(12) Patent Application Publication
(10) Pub. No.: US 2015/0193745 A1
(43) Pub. Date: Jul. 9, 2015

(54) SYSTEMS AND METHODS FOR MANAGING GRATUITY DISBURSEMENT

(71) Applicants: Mark Handwerger, Washington, DC (US); Gregory Dotson Bremer, Washington, DC (US)

(72) Inventors: Mark Handwerger, Washington, DC (US); Gregory Dotson Bremer, Washington, DC (US)

(21) Appl. No.: 14/147,192

(22) Filed: Jan. 3, 2014

(51) Int. Cl. G06Q 20/10; G06Q 20/20; G06Q 20/02

(52) U.S. Cl. CPC G06Q 20/10; G06Q 20/108; G06Q 20/023; G06Q 20/20

(57) ABSTRACT

Methods and systems for processing and managing gratuity disbursements are disclosed. A method receives merchant sales transaction data, the data including gratuity amounts and an indication of an employee associated with the gratuities. The method calculates an employee gratuity total as a sum of each gratuity amount associated with the employee and then transmits instructions to credit a financial account associated with the employee by an amount equaling the gratuity total. A system includes a memory storing instructions that, if executed by a processor, cause the processor receive data corresponding to merchant sales transactions, the data including gratuity amounts and an indication of an employee associated with the gratuity amounts. The system calculates an employee gratuity total as a sum of each gratuity amount associated with the employee and transmits instructions to credit a financial account associated with the employee by an amount equaling the gross or net gratuity total.

### BACKGROUND

1. Field of the Disclosed Technology

The present disclosure relates generally to processing gratuities, and more particularly, to systems and methods for managing disbursements of gratuities to employees.

2. Related Art

Credit card, debit card, gift card, online purchases, ‘deal-of-the-day’ sales (i.e., GroupOn or LivingSocial pre-paid daily deals), and other non-cash sales transactions represent a growing proportion of payments received by businesses whose staff and employees receive gratuities (i.e., tips). Many businesses with tipped employees, such as hospitality industry establishments, customarily distribute tips to such employees upon completion of each workday or shift. Tips are traditionally distributed in cash form by many such businesses, such as, for example, bars, restaurants, hotels, salons, taxi companies, and other establishments with tipped staff and employees. Due to the increasing prevalence of credit, debit, and gift card payments received by these businesses, they often lack sufficient cash on hand to pay staff for tips included in non-cash payments received during a given work period. This tip disbursement process is sometimes referred to as ‘tipping out.’ The tipping out process can cause short-term cash shortages for businesses that receive a relatively large proportion of their revenue as non-cash payments and distribute tips in cash.

Traditional tip disbursement techniques compensate for short term cash shortages associated with distributing tips in cash by making additional trips to a bank for cash, particularly when large amounts of cash are anticipated to be necessary to distribute tips after busy workdays/shifts, such as, for example, weekend and holiday shifts. Another prior solution to such cash shortages involves distributing credit card and debit card tips with staff paychecks. However, this technique can be cumbersome to manage and problematic for staff who prefer to receive their tips more quickly. This prior solution can meet resistance from staff and employees who are accustomed to industry norms and standards of receiving tips shift-by-shift, particularly tipped employees who customarily meet living expenses with tip income. For many tipped staff and employees, hourly wages represent a relatively small percentage of their total compensation. For example, hourly wages for some tipped employees are low enough to result in these employees having substantially all of their paychecks withheld for taxes, medical benefits, and other deductions. For these and other reasons, many tipped employees are reluctant to defer receiving tips until a pay cycle has completed.

### SUMMARY

In accordance with one aspect of the disclosed technology, there is a method for processing gratuities. The method receives data corresponding to one or more sales transactions at a merchant location, where the data includes, for each of the one or more sales transactions: a gratuity amount; and an indication of a merchant employee associated with the gratuity amount. The exemplary method then calculates a gratuity total for the employee as a sum of each gratuity amount associated with the employee and transmits instructions to credit a financial account associated with the employee by an amount equaling the gratuity total.

In accordance with another aspect of the disclosed technology, a system for processing gratuities is configured to receive data corresponding to sales transactions at a merchant location, the data includes, for each of the sales transactions: a gratuity amount; and an indication of a merchant employee associated with the gratuity amount. The system is configured to calculate a gratuity total for the employee as a sum of each gratuity amount associated with the employee. The system is further configured to transmit instructions to credit an account associated with the employee by an amount equaling the gratuity total.

In accordance with yet another aspect of the disclosed technology, a non-transitory computer readable storage medium has program instructions stored thereon for processing gratuity disbursements, the instructions being executable by a processor of a computing device. The instructions include instructions for receiving data corresponding to sales transactions at a merchant location. The data includes, for each of the one or more sales transactions: a gratuity amount and an indication of a staff member associated with the gratuity amount. The instructions also include instructions for calculating a gratuity total for the staff member as a sum of each gratuity amount associated with the staff member and instructions for transmitting a request to credit transfer funds equaling the gross or net gratuity total from a merchant account associated with the merchant to a financial account associated with the staff member.

Exemplary methods and systems automate processing and disbursement of gratuities (i.e., tips) to employees. The methods and systems access a financial transaction card processing system via a network to distribute tips to financial accounts associated with debit cards issued to tipped employees. Embodiments address management needs for management of tip disbursement and employee concerns by disbursing tips as credits to debit cards and accounts assigned to tipped staff members. In one embodiment, after each work period (i.e., shift), credit and debit tips are correlated to individual employees and electronically transferred to the employee's account as a credit applied to their debit card account. Exemplary embodiments advantageously eliminate the need for a manager to go to a bank or perform time-consuming tasks associated with manually counting and distributing cash tips to each employee as part of a cash-based tip out process. Embodiments disclosed herein advantageously provide tipped employees with relatively quick access to their tips, and in cases where an employee receives cash tips, that employee is able to receive such cash tips directly.

### BRIEF DESCRIPTION OF THE DRAWINGS

Embodiments of the disclosed technology are described below with reference to the attached drawings, in which:

FIG. 1 is a block diagram of a system for managing cashless disbursement of gratuities according to an exemplary embodiment;

FIG. 2 illustrates high level data flow in a financial processing architecture for managing tip disbursement according to an exemplary embodiment;

FIG. 3 is a message sequence chart of a high level call flow for a method of managing cashless disbursement of gratuities according to an exemplary embodiment;

FIGS. 4A and 4B depict use of a database to map tip disbursements to employees working at multiple locations to respective debit card accounts, according to exemplary embodiments;

FIG. 5 depicts an exemplary monthly financial report generated by a gratuity management system according to an exemplary embodiment;

FIG. 6 depicts an exemplary yearly financial report generated by a gratuity management system according to an exemplary embodiment;

FIG. 7 depicts an exemplary yearly summary financial report generated by a gratuity management system according to an exemplary embodiment;

FIG. 8 depicts an exemplary submission of gratuity data from a merchant to a gratuity management system according to an exemplary embodiment;

FIG. 9 is a flow-chart illustrating steps for an exemplary method for managing cashless disbursement of gratuities; and

FIG. 10 is a diagram of an exemplary computer system in which embodiments of the present disclosure can be implemented.

### DETAILED DESCRIPTION

Embodiments of the disclosed subject matter are generally directed towards methods and systems for processing and managing disbursements of gratuities (i.e., tips). Exemplary systems and methods perform financial analysis based on sales, gratuity and wage data to produce payroll and labor cost management reports. By way of example, the management reports can include ‘tip awareness’ reports indicating an amount of tips that supplement base compensation (i.e., hourly pay rates, wages, or salary) to enable ‘tip awareness.’ Tip Accountability' reports can ensure that tips are not diverted. Embodiments reduce compliance risks by providing tip oversight, which ensures legality adherence. Embodiments perform overall payroll and compensation analysis to enable merchants (i.e., businesses) with tipped employees to compare their employee's total compensation to historical norms in a given market sector and/or region. Embodiments require only one debit card for each employee, even in cases where particular employees work at multiple merchant locations. Exemplary systems and methods manage and automate reimbursements from tipped employees by deducting reimbursements from tips prior to disbursement.

Systems and methods disclosed herein provide cash management controls which result in reduced bank fees by reducing the number of transactions and withdrawals from a merchant's financial institutions. Embodiments provide systems and methods for cashless tip processing and disbursement, thus reducing cash demands for merchants by lowering amounts of cash needed on-hand at merchant locations for tip disbursement. Embodiments also enable recoupment of credit card discount fees (which in some cases can equal or exceed 0.5% of gross revenues). Exemplary systems produce financial reports including an annual report providing merchants (i.e., business owners and managers) with an overview of overall staff rates for a given year or a subset thereof (i.e., a quarter, year-to-date, or a selected range of weeks or months). The reports can be interactive reports rendered in a graphical user interface (GUI) and based on merchant data stored in a database. For example, an annual total tab of a yearly report can include an hourly rate, hours, overtime worked, cashless gratuities (i.e., tips paid via credit or debit cards and disbursed as ‘TipQuick tips’), estimated/expected cash tips over and above the cashless tips, and the effective hourly rate. The annual report can include hours worked for each month as well as tips for each month (i.e., in monthly tabs).

Exemplary financial analysis and reporting provided by systems and methods disclosed herein include user interfaces and reports that allow an owner of a merchant (i.e., a merchant location or business) to verify that managers are working certain shifts, such as, for example, bartender shifts and parties. The reports indicate how the salaries of managers reflect work during such shifts, including gratuities associated with the shifts. Exemplary reports enable the owner to quickly ensure the total compensation for salaried employees is appropriate by viewing summary data rather than having to delve into details regarding individual shifts, gratuities, et al.

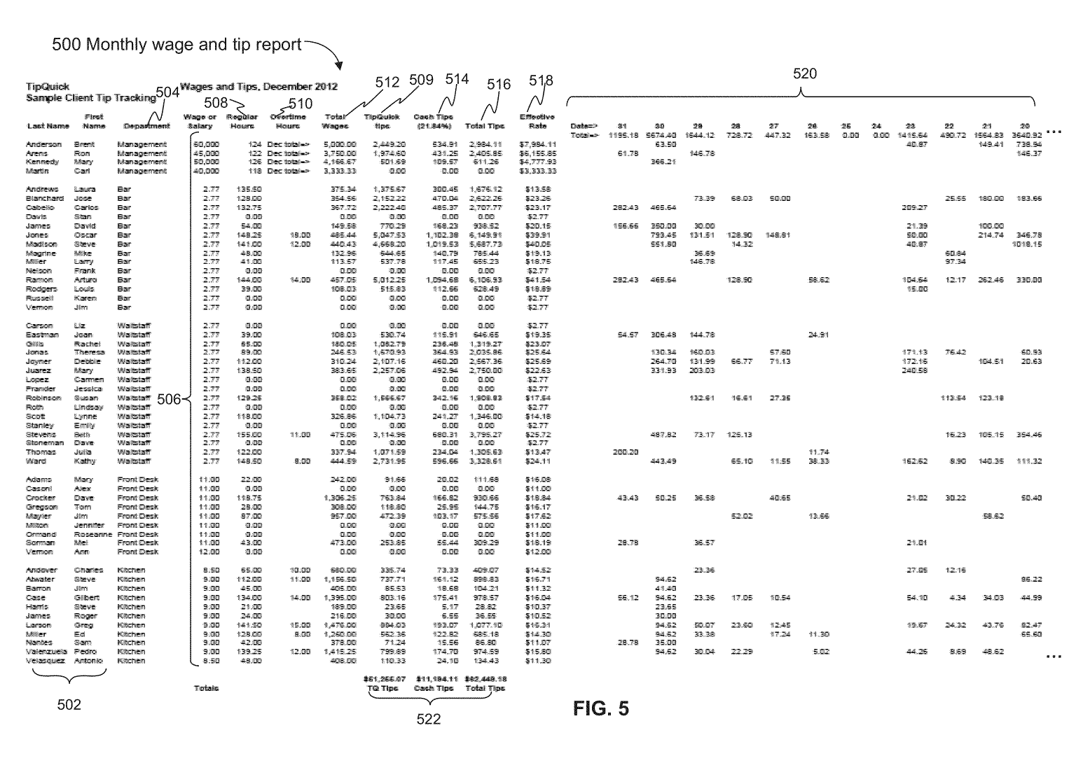

Embodiments provide user interfaces (UIs) and reports that allow owners and managers to quickly visualize overall hourly rates for various departments and ensure they are within desired levels for a given merchant (i.e., an owner's business and/or a merchant location managed by a manger). Such UIs and reports are especially helpful in environments where ‘customer facing’ staff, such as, for example, servers and bartenders, split a portion of their gratuities with other staff such as, for example, barbacks, bussers, hostesses, and other staff members. For example, the UIs and reports allow an owner or manger to quickly determine if an hourly wage for a given staff member needs to be adjusted in light of gratuities (including cashless tips, pooled/shared tips and cash tips). According to this example, a restaurant or bar manager can determine that an hourly wage paid to staff such as barbacks can be reduced based on an effective wage that includes gratuities being higher than expected or budgeted for a barback position. The reports allow owners and managers to selectively reduce an hourly wage for certain tipped staff members as compared to other staff, such as kitchen staff who are not receiving gratuities, so that the effective compensation for the tipped staff members is comparable to staff who are not receiving gratuities. By using the exemplary reports described below with reference to FIGS. 5-8, owners and managers can quickly determine, based on the portion of tips certain staff members (i.e., barbacks) are making, whether the staff members are being paid more (or less) than expected or budgeted for their position. Because the UIs and reports enable owners and managers to quickly visualize total effective compensation including wages, overtime, cashless gratuities and cash gratuities, the owners and managers can selectively adjust hourly wages for certain staff members while keeping the staff members' total compensation within a desired range.

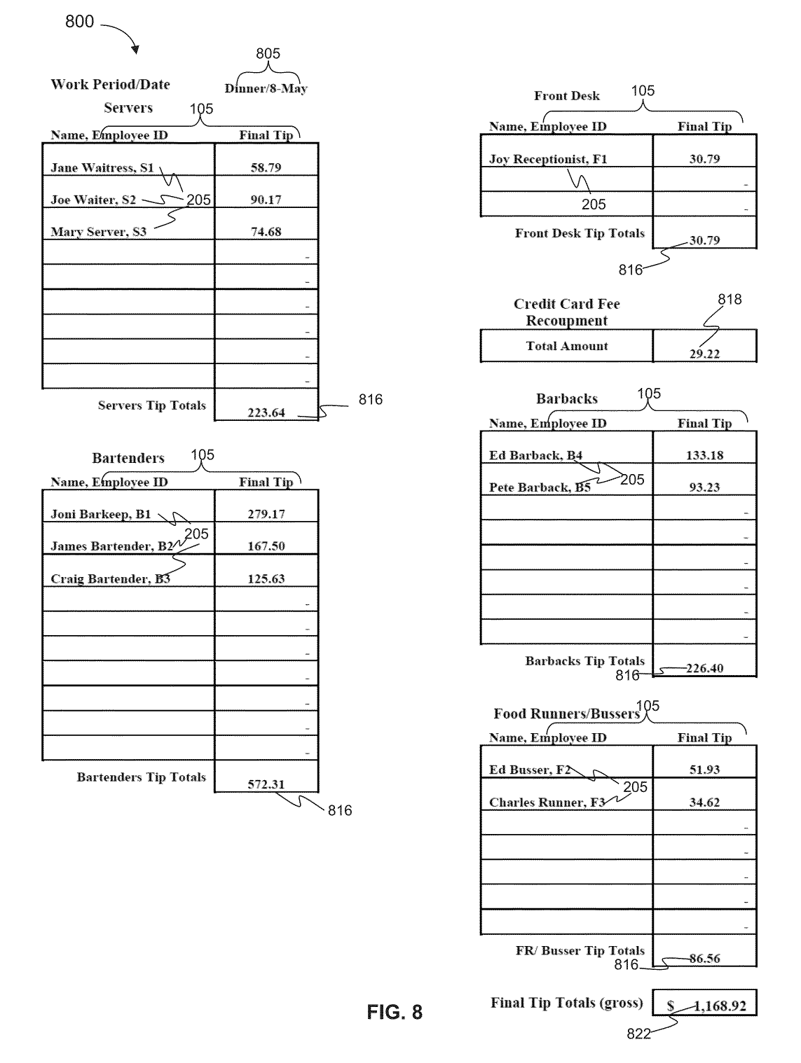

The example reports and data illustrated in FIGS. 5-8 depict how some staff members, such as bussers and food runners in a kitchen staff do not get the same amount of tips as other staff members. The financial reports in FIGS. 5-7 and tip data in FIG. 8 can indicate that staff members receiving less tip compensation may only be used during extremely busy shifts. The reports allow owners and manager to quickly determine this and potentially adjust (i.e., increase/raise) the hourly rate of the staff members receiving relatively low tip compensation so that they fall into a desired compensation range for their positions.

As used herein, the terms “credit card number,” “credit card,” “customer payment card,” and “debit card” are sometimes used interchangeably to refer to a credit card, debit card, pre-paid card, hybrid card, financial transaction card number, payment account number, plastic or virtual card number (VCN), or nearly any other account number that facilitates a financial transaction using a transaction clearance system. Employee debit cards and other financial transaction card numbers can be generally viewed as being more readily issued and disposed of because they do not require the establishment of a line of credit, and can be linked to various controls (amounts, cumulative amounts, duration, types of merchants, geographic controls, to name a few).

As used herein, the terms “customer”, “consumer”, “card user” and “cardholder” can be used interchangeably and can include any user purchasing goods and/or services at a merchant. Unless specifically stated differently, in an embodiment, a customer is interchangeably used herein to identify a human customer, or a group of customers conducting a purchase transaction. Besides a human customer who can make purchases at a merchant, a software application can be used to process purchases and pay tips. Accordingly, unless specifically stated, the terms “customer”, “consumer”, “cardholder”, and “card user” are not limited to human beings.

As used herein, the terms manager, “general manager”, and owner can be used interchangeably and can include any user authorized to process and manage tip disbursement on behalf of a merchant. Unless specifically stated differently, in an embodiment, a manager or general manager (GM) is interchangeably used herein to identify a human user, or a group of users responsible for managing one or more merchant locations. Besides a human GM who can manage a merchant location, and a human owner who can request financial reports related to tip data, a software application can be used to disburse tips, configure tip processing, and submit requests for financial reports. Accordingly, unless specifically stated, the terms manager, “general manager” and owner are not limited to human beings.

As used herein, the terms “debit card recipient”, “employee”, and “staff” are used interchangeably to refer to anyone associated with a merchant who receives tips. Staff members can be part-time employees, temporary workers (i.e., temps), freelancers, independent contractors, occasional employees, or any other person authorized to receive tips stemming from purchases made at a merchant. Accordingly, unless specifically stated, the terms “debit card recipient”, “tipped staff”, “tipped employees”, employee, staff and “staff member” are not limited to employees of a merchant.

Further, as used herein, the term “issuer” can include, for example, a financial institution such as a bank, credit union, or savings and loan (S&L) association issuing a credit or debit card, a financial institution issuing a merchant account or line of credit, a merchant issuing a merchant specific card (i.e., a gift card), a stand-in processor configured to act on-behalf of a card issuer, or any other suitable institution configured to issue a financial card. Finally, as used herein, the term merchant can refer to, for example, a business location, a point-of-sale (POS) terminal at a merchant, or any other suitable entity, institution or device configured to initiate a financial transaction per the request of a customer.

### Exemplary System

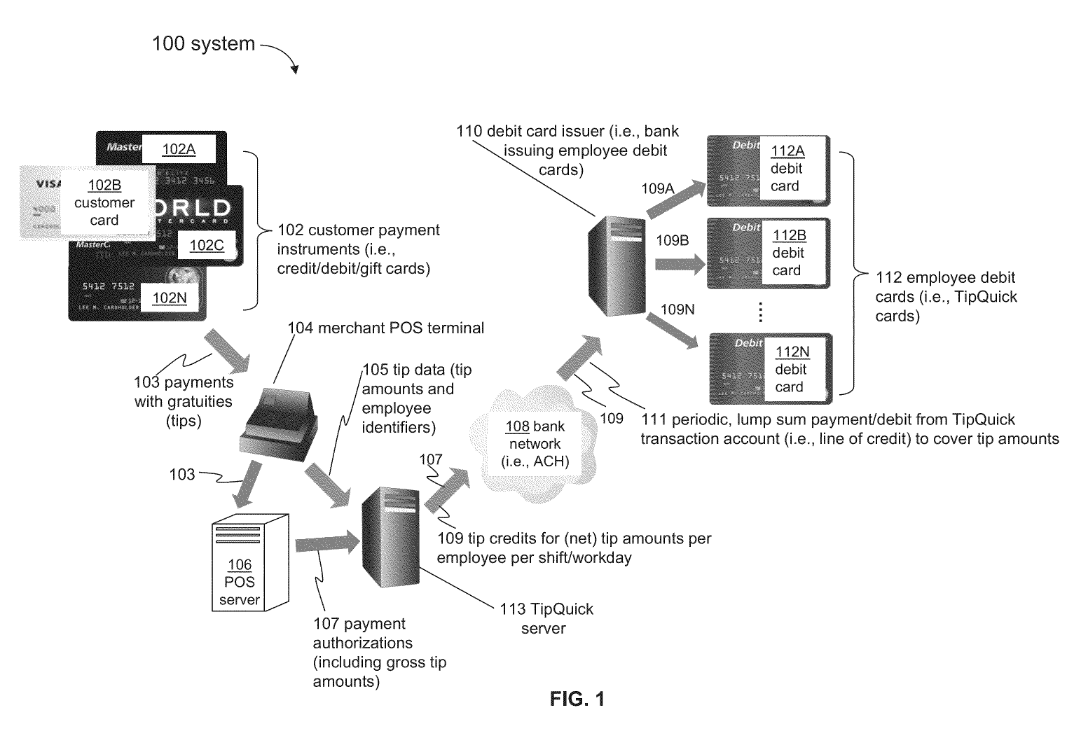

FIG. 1 illustrates data flow between components of a gratuity management system operating within a financial processing operating environment for managing tip disbursement, according to an exemplary embodiment. In particular, FIG. 1 is a block diagram of an exemplary operating environment for a gratuity management system 100 for tracking gratuity (i.e., tip) data associated with electronic payments processed by a payment processing network, according to exemplary embodiments of the present disclosure. As implemented in the presently described exemplary embodiment, the system 100 depicted in FIG. 1 receives payments 103 from consumer payment cards 102 (i.e., payment cards 102A-N) at a merchant point of sale (POS) terminal 104. The merchant POS terminal 104 can be installed at a merchant's place of business, such as, for example, a restaurant, salon, spa, hotel, club, bar, taxi, limousine, or other merchant locations with tipped staff and employees. As shown in FIG. 1, the system 100 also includes a POS server 106 and a TipQuick server 113, which communicates with a bank network 108 that facilitates the routing of payment card transactions for authorization, and a debit card issuer 110 (i.e., an issuer of debit cards for the merchant's employees). As will be appreciated by those skilled in the relevant art(s), while exemplary payment cards 102A-N are depicted in FIG. 1 as physical VISA® and MASTERCARD® payment cards, payment cards 102A-N can be embodied as any credit card, debit card, pre-paid card, gift card, hybrid card, a virtual card number (VCN), or any other card or card account number that facilitates a financial transaction with POS terminal 104 at a merchant location. For example, financial transaction card processors, networks, and issuers of customer payment cards 102 also offer prepaid card processing so that payment cards 102 can be embodied as prepaid or ‘gift’ cards. Customer payment cards 102 are not limited to physical, plastic cards, and can be embodied as other customer payment instruments. For example, payments 103 that include tips can be made using pre-paid instruments (i.e., GroupOn or LivingSocial pre-paid daily deals), cash, checks, vouchers, virtual card numbers (VCNs), or a combination of customer payment instruments. For example, a bar tab or restaurant bill can be paid partially with a customer payment card 102 and partially with cash or check. VCNs are formatted and are processed the same as regular credit and debit card numbers by merchants, but at the issuing bank (i.e., issuer) or card processor (e.g., VISA®, MASTERCARD®, AMERICAN EXPRESS®, DISCOVER®, DINERS CLUB®), the VCN is mapped in a database to a regular card number for payment authorization checking VCNs can also be mapped to controls that are in addition to the normal authorization checking that can be set by the customer/card holder, such as spending limits (limiting a maximum amount per transaction and/or a limit over a given time period), limits on types of merchants, limits for a single merchant, geographic location based spending and use controls, etc.

With reference to FIG. 1, the TipQuick server 113 provides various services and reports to support merchants with tipped employees. One such service allows a merchant to disburse tips electronically by crediting respective employee debit cards 112A-N associated with respective tipped employees. For each tipped employee, a respective debit card 112A-N can be issued by the debit card issuer 110. In an embodiment, each employee debit card 112A-N is associated with a respective employee financial account. In embodiments, the bank network 108 can be an Automated Clearing House (ACH) network and the TipQuick server 113 sends instructions for an ACH credit transfer equaling the total tip credits 109 (i.e., a gross or net gratuity total) from the debit card issuer 110 to the a debit card 112 with a tipped employee. The TipQuick server 113 allows merchants and authorized users, such as, a general manager (GM) of a restaurant or bar, to set custom controls on the periodicity of tip disbursements (i.e., per shift, daily, weekly) to employee debit cards 112, set up new debit cards 112 for new employees, cease transmissions of tip credits 109 for terminated employees, and even block transactions that they deem inappropriate.

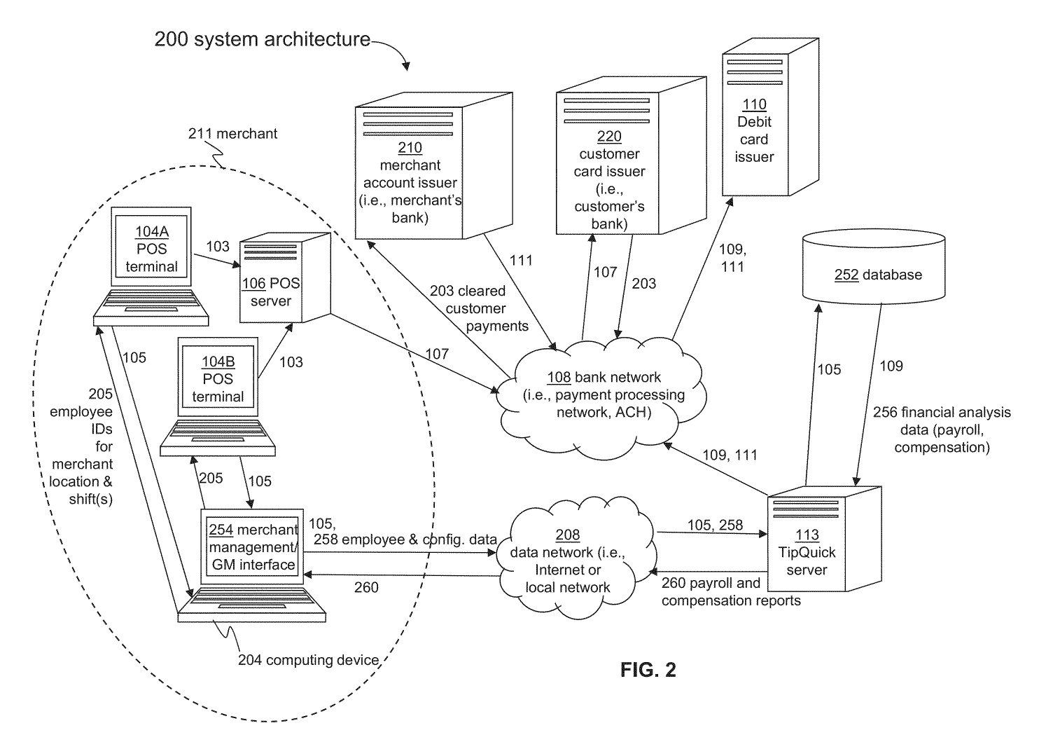

As described below with reference to FIG. 2, the bank network 108 can be embodied as a payment processing network that processes transactions that use financial transaction cards, such as customer payment cards 102 and employee debit cards 112, by receiving authorization requests from merchants in a conventional manner. Exemplary payment processing networks include MASTERCARD®, VISA®, AMERICAN EXPRESS®, DISCOVER®, DINERS CLUB®, etc., to name a few. As would be understood by those skilled in the relevant art(s), ACH transactions, such as applying tip credits 109 to debit cards 112, can be processed by an electronic network that is separate from a network used to handle credit card payments. For simplicity, FIGS. 1 and 2 depict a single bank network 108 for handling financial transactions within system 100. The bank network 108 can communicate by two-way communication to the TipQuick server 113 and the debit card issuer 110.

As shown in FIG. 1, a payment 103 associated with customer payment card 102 is received at the POS terminal 104 when a transaction is initiated by a customer using a customer payment card 102. In an embodiment, the POS terminal 104 includes a TipQuick plug-in so that system 100 can be integrated with existing POS terminals 104 in use by merchants using system 100 to disburse gratuities to employee debit cards 112. According to this embodiment, the POS plug-in forwards payments 103 to the POS server 106 and forwards tip data 105 to the TipQuick server 113. In alternative embodiments, the TipQuick server 113 receives the tip data 105 directly from a merchant's computing device (see, e.g., computing device 204 in FIG. 2) instead of a POS system. According to one such embodiment, the tip data 105 can be input into an administrative user interface (see, e.g., merchant management interface 252 in FIG. 2) without requiring data flow between a POS system and the TipQuick server 113. That is, the system 100 does not require that the TipQuick server 113 be integrated with or in communication with a POS terminal 104 or a POS server 106.

As depicted in the exemplary embodiment of FIG. 1, tip data 105 indicates a tip amount (i.e., a gross tip amount prior to any deductions) and an employee identifier. The tip data 105 can include, for example, a tip amount indicated by a customer on a credit card slip along with data identifying a staff member, such as a server, bartender, or other staff, associated with the payment 103. In one embodiment, the data identifying a staff member can be a unique employee ID. In the example provided in FIG. 1, the POS server 106 can forward an authorization request 107 including the tip amount to the TipQuick server 113, which in turn sends the authorization request 107 to the bank network 108.

In some embodiments, the TipQuick server 113 calculates the total gross tips per employee for a given time period. In an example embodiment shown in FIG. 1, the TipQuick server 113 can receive tip amounts with tip data 105 from the POS terminal 104. In an additional, alternative embodiment provided in FIG. 1, the TipQuick server 113 receives gross tip amounts (i.e., before any deductions) as indicated in payment authorization requests 107 from the POS server 106. In another embodiment, the TipQuick server 113 receives tip data 105 from a merchant's computing device instead of a POS system. For example, the TipQuick server 113 can receive a daily communication, such as for example, an email message with an attached file including the tip data 105, from a merchant's general manager (GM). The TipQuick server 113 is configured to periodically sum up total tips per employee. For example, total tip amounts can be summed per shift, daily, weekly, or whenever tipping out occurs for a merchant's employees. As described below with reference to FIG. 8, the TipQuick server 113 can also be configured to sum up total tips per employee category, such as, for example, servers, bartenders front desk, barbacks, food runners, bussers, and other types of employees or staff. The TipQuick server 113 forwards payment authorization requests 107 and tip credits 109 corresponding to tip amounts for respective employees to the bank network 108. The authorization requests 107 received from the POS server 106 are also sent to the bank network 108, which then routes the authorization requests 107 to an issuer (not shown) of the corresponding customer payment card 102. In an alternative embodiment (not shown), authorization requests 107 are sent directly from the POS server 106 to the bank network 108, bypassing the TipQuick server 113. According to this embodiment, the TipQuick sever 113 receives the tip data 105 and gross tip amounts, either from the merchant POS terminal 104 directly, or via the POS server 106.

As shown in FIG. 1, tip credits 109 can be sent to the bank network 108 as net tip amounts per tipped employee per shift or workday. In accordance with an embodiment, authorization request 107 indicates the total payment 103 amount, including the gross tip amount and other transaction details for the sales transaction to be authorized and for bank network 108 to debit a customer payment card 102 associated with the payment 103. Tip data 105 includes a gross tip amount and an employee ID, along with other data, such as, for example, a merchant ID, and other tip details for the tip credits 109 to be authorized and for bank network 108 to credit an employee debit card 112 account linked to the employee ID. According to an embodiment, TipQuick server 113 calculates net tip credits 109 and sends instructions to credit debit accounts/debit cards 112, after taking into account any applicable deductions, garnishments, and withholdings. For example, if a merchant needs to deduct uniform costs, withhold taxes, or garnish portions of gross tip amounts, the TipQuick server 113 can calculate net amounts for tip credits 109 before sending instructions to the debit card issuer 110 via the bank network 108.

The bank network 108 then sends authorization responses corresponding to the tip credits 109 to the debit card issuer 110 of the employee debit cards 112A-N. For example, if the TipQuick server 113 determines that a payment 103 includes a tip associated with a given employee, the TipQuick server 113 sends instructions to the bank network 108 to credit that employee's debit card 112 by the tip credit 109 amount. Based on the instructions received from the TipQuick server 113, the bank network 108 sends an authorization response to the debit card issuer 110 indicating that the tip credit 109 is to be credited to the debit card 112 associated with the employee. As shown in FIG. 1, employees of a merchant are assigned respective debit cards 112A-N, which can be embodied as TipQuick cards issued by the debit card issuer 110. In some embodiments, the debit card issuer 110 is a bank and the merchant's employees can access their tips as soon as the corresponding tip credits 109 are posted/credited to their TipQuick debit cards 112. For example, if the debit card 112A is issued to an employee of the merchant, that employee's tips for a given period (i.e., a shift, workday, or workweek) are credited by the debit card issuer 110 via tip credits 109A. At this point, funds corresponding to tip credits 109A are available to the employee and can be accessed and spent as any other balance on a conventional debit card. As will be appreciated by those skilled in the relevant art(s), the debit cards 112A-N can be any type of debit card issued by an issuing financial institution (i.e., debit card issuer 110). For example, the employee debit cards 112 can be VISA® or MASTERCARD® debit cards issued by a bank, credit union, or savings and loan (S&L) association.

With continued reference to FIG. 1, the TipQuick server 113 can also send instructions to the bank network 108 to authorize a lump sum payment 111 to the debit card issuer 110 in order to cover amounts in tip credits 109. In the exemplary embodiment depicted in FIG. 1, the lump sum payment 111 can be a periodic transaction that debits a TipQuick transaction account, such as, for example, a line of credit. In this embodiment, the TipQuick transaction account is automatically debited on an as-needed basis to cover an aggregate amount of tips included in tip credits 109. For example, if the system 100 determines that tip credits 109 being processed may create a shortfall in the TipQuick transaction account, a lump sum payment 111 sufficient to cover the shortfall can be sent to the debit card issuer 110 via the bank network 108. In an embodiment, lump sum payments 111 are used solely for the TipQuick transaction account and do not involve individual merchants or merchant accounts. According to this embodiment, a merchant will not initiate a lump sum payment 111 to their own merchant account from the TipQuick transaction account.

### Exemplary System Architecture

FIG. 2 is a block diagram of an exemplary system architecture for managing cashless disbursement of tips associated with electronic payments. In particular, FIG. 2 illustrates exemplary data flows between components of system architecture 200, including depictions of bi-directional communications between components used to manage tips included in electronic payments. FIG. 2 is described with continued reference to the embodiment illustrated in FIG. 1. However, FIG. 2 is not limited to that embodiment.

As shown in FIG. 2, a merchant 211 has POS terminals 104A-B, a POS server 106, and a computing device 204. In some embodiments, the POS terminals 104A and 104B, the POS server 106, and the computing device 204 are physically located at the merchant 211 (i.e., at the merchant's location). In alternative embodiments, one or more of the computing device 204 and the POS server 106 can be located remote from the merchant 211 and accessed via a network, such as, for example, the data network 208. Although two POS terminals 104 are shown in FIG. 2, it is to be understood that in alternative embodiments, the merchant 211 may have more than two POS terminals 104, or only a single POS terminal 104 (see., e.g., FIG. 1). The merchant computing device 204 is also configured to render a merchant management interface 254. In the exemplary embodiment depicted in FIG. 2, the merchant management interface 254 can be accessed by an authorized user, such as, for example, a general manager (GM) for the merchant 211. The merchant management interface 254 can be used to submit employee and configuration data 258 to the TipQuick server 113. The employee and configuration data 258 can include employee information for the merchant 211, such as, for example, employee names, employee IDs 205, employee departments, employee categories (i.e., title, role, type), withholding/garnishment information, wage or salary, and account numbers for employee debit cards 112. The employee and configuration data 258 can also include, for example, configuration data for the merchant 211, such as shift information, tipping out schedules, periodicity/frequency of tip disbursements, merchant locations, and a cushion or minimum balance threshold for an account used by the merchant 211 to pay tip credits 109. As shown, the employee and configuration data 258 can be transmitted to the TipQuick server 113 via a data network 208. In embodiments where the TipQuick server 113 is remote from the merchant 211, the data network 208 can be an external communications network, such as, for example, the Internet. In alternative embodiments where the TipQuick server 113 is located at the merchant 211, the data network 208 can be a local network.

As illustrated in FIG. 2, the merchant management interface 254 can also be used to submit employee identifiers (IDs) 205 to the POS terminals 104A-B so that tip data 105 sent back to the merchant computing device 204 can be correlated to employees working at the merchant 211 during a given shift. In the example embodiment illustrated in FIG. 2, the employee IDs 205 are for employees working at a given merchant location during one or more shifts. The merchant computing device 204 can be configured to receive tip data 105 from the POS terminals 104A-B. In an alternative embodiment (not shown), the merchant computing device 204 sends employee IDs 205 to the POS server 106, which in turn disseminates the employee IDs 205 to the POS terminals 104A-B. According to this embodiment, the POS server 106 aggregates and sends tip data 105 corresponding to payments 103 received from the POS terminals 104A-B to the merchant computing device 204. Exemplary employee IDs 205 for a given shift along with associated tip data 105 is described below with reference to FIG. 8.

As seen in FIG. 2, the debit card issuer 110, a merchant account issuer 210, and a customer card issuer 220 can each communicate with the bank network 108. In certain embodiments, the merchant account issuer 210 can be the same or a different entity from the debit card issuer 110. After a POS terminal 104 sends a payment 103 to the POS server 106, a corresponding payment authorization request 107 is sent from the POS server 106 to the customer card issuer 220 via the bank network 108. The bank network 108 can include a conventional card processing system and database (not shown) for routing to the appropriate issuer (debit card issuer 110, merchant account issuer 210, or customer card issuer 220) and processing of transactions for authorization. The bank network 108 can route authorization requests 107 to the customer card issuer 220 (i.e., the bank that issued the customer payment card 102 used to make a payment 103 at the merchant 211). Once a payment 103 indicated in the authorization request 107 has been authorized and cleared, the customer card issuer 220 can send a cleared customer payment 203 to the merchant account issuer 210 (i.e., the merchant's bank) via the bank network 108. The bank network 108 can perform payment authorization, clearance, settlement, and other functions of a conventional payment processing system. According to embodiments, disbursement of tip credits 109 to employee debit cards 112 occurs asynchronously with respect to authorization and clearance of payments 103. That is, the TipQuick server 113 can send instructions to the debit card issuer 110 to credit debit cards 112 for employees of the merchant 211 without waiting for cleared customer payments 203 to be sent to the merchant account issuer 210.

The TipQuick server 113 is configured to send transaction details for tip credits 109 indicating which employee debit card (112A, 112B, and 112N) is to get what tip credit (109A, 109B, and 109N) for a net tip amount stemming from a payment 103 transaction. FIG. 2 also depicts how tip data 105 is sent from the merchant computing device 204 to the TipQuick server 113 via the data network 208. The TipQuick server 113 can be configured to manage tip pooling and tip sharing. For example, each tipped employee working a shift during which payments 103 are received at the merchant 211 can receive a certain percentage or portion of the total gross tips indicated in the tip data 105 for that shift. The percentages of tips to be pooled and shared amongst employees can be configured using the merchant management interface 254 and transmitted from the merchant computing device 204 as part of the employee and configuration data 258.

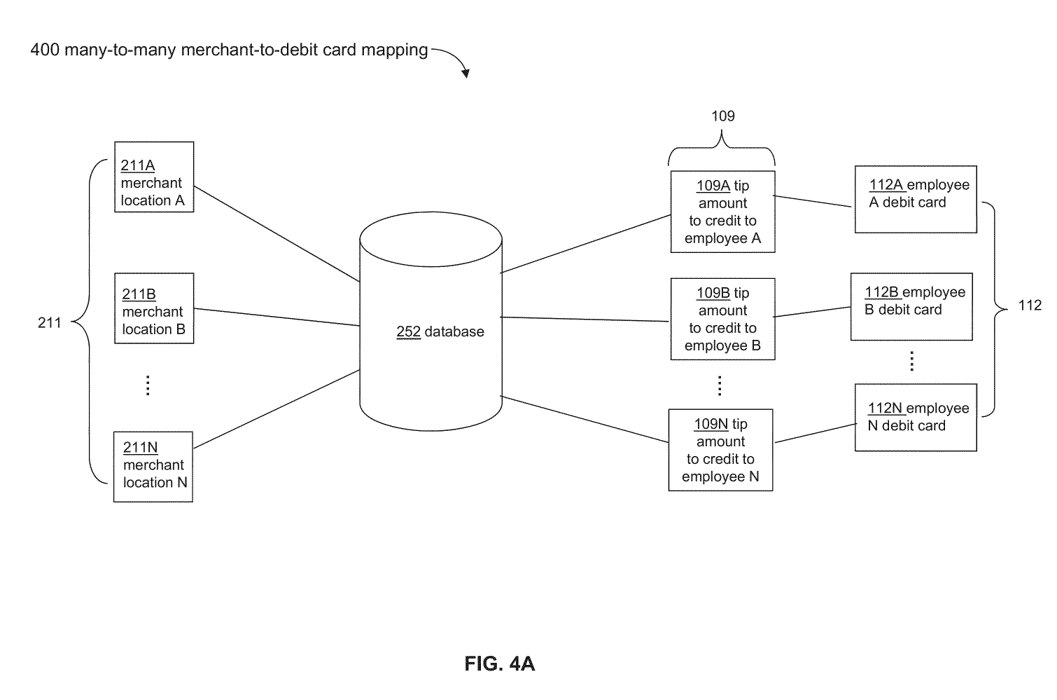

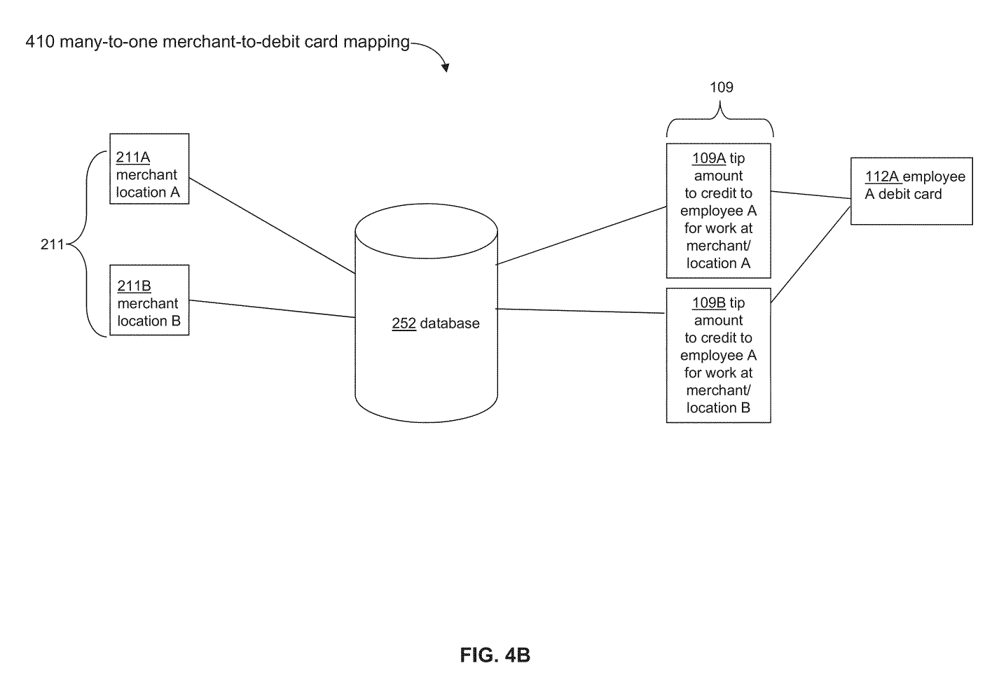

In some embodiments, the tip data 105 received at the TipQuick server 113 is saved in a database 252. As described below with reference to FIGS. 4A and 4B, the database 252 can include a table mapping merchant locations to employee identifiers (i.e., employee IDs) and employee IDs to particular employee debit cards 112. The mappings in the database 252 enable the TipQuick server 113 to retrieve tip credits 109 to be credited to employee debit cards 112. According to embodiments, the tip credits 109 are adjusted by the TipQuick server 113 to account for any deductions, garnishments, and withholdings, and then sent to the debit card issuer 110 via the bank network 108. In the embodiment illustrated in FIG. 2, the database 252 is remote from the TipQuick server 113. According to this embodiment, the database 252 can be hosted on a remote database server accessible from the TipQuick server 113. In an alternative embodiment, the database 252 can be hosted locally on the TipQuick server 113.

The communication links depicted in system 100 and architecture 200 between the various components can be through public and/or private networks or virtual private networks (e.g., data network 208) and private networks (e.g., bank network 108). Depending on the encryption status of transaction data, data may be transmitted to/from the merchant 211, the debit card issuer 110, and the merchant account issuer 210 via secure network connections or data links. Non-limiting examples of such secure connections include connections made using the Secure Sockets Layer (SSL) protocol or the Transport Layer Security (TLS) protocol. As would be understood by those skilled in the relevant art(s), SSL and TLS connections are made via cryptographic protocols to provide communication security over data networks such as the Internet. SSL and TLS protocols encrypt segments of data network connections using asymmetric cryptography for key exchange, symmetric encryption for confidentiality, and message authentication codes for message integrity. The data network 208 may be a data communications network such as the Internet. In embodiments, the data network 208 can be one or a combination of networks, such as the Internet, a Wide Area Network (WAN), WiFi, a Local Area Network (LAN), or any other wired or wireless network.

In an embodiment, the merchant 211 can register or enroll as a subscriber to one or more services offered by the TipQuick server 113. In one embodiment, the merchant 211 can use the TipQuick server 113 to manage distribution of tips to employee debit cards 112. Merchants 211 can also opt to subscribe to or utilize other services offered by the TipQuick server 113. For example, restaurant, bar, salon, spa, limousine, taxi, lodging, and other hospitality merchants 211 with tipped employees in multiple locations can subscribe to services that provide payroll and compensation reports 260 based on financial analysis data 256. As depicted in FIG. 2, the financial analysis data 256 can be retrieved from the database 252 by the TipQuick server 113, which then creates the payroll and compensation reports 260. Exemplary payroll and compensation reports 260 are described below with reference to FIGS. 5-7. The payroll and compensation reports 260 can be transmitted to the merchant computing device 204 via the data network 208 and then rendered in the merchant management interface 254.

The architecture 200 allows the merchant 211 to link tip data 105 to employee debit cards 112. As will be apparent to persons skilled in the relevant art, an employee identifier included in employee ID 205 may be the employee's debit card account number or an alternative identifier linked to the employee's debit card 112. Examples of alternative identifiers include the employee's employee number, a personal identification number (PIN), or other alphanumeric identifier (i.e., employee's name) linked to the employee's debit card account.

In embodiments, transmission of payments 103, payment authorization requests 107, and cleared customer payments 203 are carried out asynchronously to the flow of tip data 105 and corresponding tip credits 109. In this way, the tip credits 109 can be determined and disbursed to employee debit cards 112 prior to, during, or after processing payment transactions for payments 103. Such asynchronous processing enables the merchant 211 to determine whether a given payment 103 includes tip data 105 that will be linked to an employee's debit card 112 in cases where a purchase transaction has only been initiated, is undergoing processing and has not been completed, and post-transaction. Similarly, the initiation and processing of lump sum payments 111 from the merchant account issuer 210 to the debit card issuer 110 can be carried on an as-needed basis and asynchronously to the flow of tip data 105 and corresponding tip credits 109.

As seen in FIG. 2, a lump sum payment 111 can be initiated by the merchant account issuer 210 or the TipQuick server 113. According to embodiments, the lump sum payment 111 can be triggered automatically or manually as needed in order to ensure that there are sufficient funds to cover aggregate tip amounts in tip credits 109 to be credited to debit cards 112 by the debit card issuer 110. For example, an authorized user, such as a GM of the merchant 211, can instruct the TipQuick server 113 to initiate a lump sum payment 111 by interacting with the merchant management interface 254. Also, for example, a GM can include automated lump sum payment 111 criteria in the employee and configuration data 258 sent to the TipQuick server 113. The automated lump sum payment 111 criteria can include a default amount for lump sum payments 111, a frequency of lump sum payments 111 (i.e., weekly, monthly), and a cushion or minimum balance threshold for an account used by the merchant 211 to pay tip credits 109 such that when the TipQuick server 113 or the merchant account issuer 210 determines that the account is below the threshold, a lump sum payment 111 is sent to the debit card issuer 110.

### Exemplary Sequence for Processing and Managing Tips

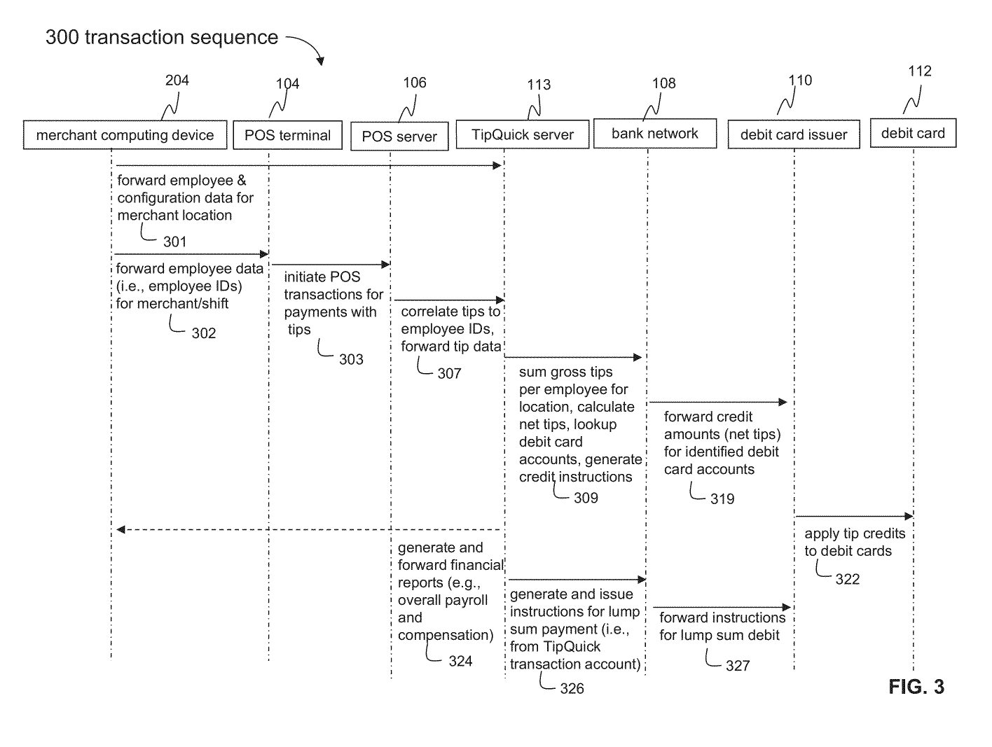

An exemplary method for processing and managing tips associated with electronic payments is described below with reference to FIG. 3. FIG. 3 is a block diagram of a high level transaction sequence 300 for disbursing and reporting cashless tips, according to embodiments of the present disclosure. FIG. 3 is described with continued reference to the embodiments illustrated in FIGS. 1 and 2. However, FIG. 3 is not limited to those embodiments.

The communication flow 300 begins at step 301. In step 301, employee data for a merchant location is forwarded from the merchant computing device 204 to the TipQuick server 113. Step 301 can be performed when a manager, such as, but not limited to, a GM of a merchant location, interacts with the management interface 254, to input employee and configuration data 258.

Next, in step 302, employee IDs 205 for a merchant 211 are forwarded from the computing device 204 to the POS terminal 104 so that the POS terminal 104 can associate tips included in payments 103 with the merchant's employees. In one embodiment, step 302 sends employee IDs 205 for employees that are assigned to work one or more shifts at a merchant location.

In step 303, after a customer initiates a purchase transaction that includes a tip, the POS terminal 104 transmits a corresponding payment 103 to the POS server 106. For example, step 303 can commence in response to determining that a customer has initiated a purchase transaction that includes a tip paid with a customer payment card 102.

In step 307, after the payment 103 is initiated, a tip amount indicated in the payment 103 is correlated to an employee ID 205 and the tip data 105 is sent to the TipQuick server 113. As noted above with reference to FIGS. 1 and 2, in alternative embodiments, tip data 105 can be forwarded to the TipQuick server 113 from the POS terminal 104 or from the merchant computing device 204.

Next, in step 309, the TipQuick server 113 sums gross tips per employee for the merchant location, calculates net tips for employees if any withholdings, deductions, or garnishments are applicable, looks up debit card accounts, and generates credit instructions for tip credits 109. Step 309 can include sending the tip data 105 to the database 252, which maps the tip data 105 to debit cards 112 and returns tip credits 109 to the TipQuick server 113. This step can also include using the employee and configuration data 258 to determine if an employee's tips are subject to any withholdings, deductions, or garnishments, such as, for example, withholdings for medical care or taxes, wage garnishments, or deductions for uniform costs. After the tip credits 109 are determined, they are forwarded to the bank network 108. The tip credits can be forwarded periodically based on a shift schedule or when tipping out for employees occurs. The schedule and frequency of forwarding the tip credits 109 can be indicated in the employee and configuration data 258.

In step 319, in response to receiving tip credits 109, the bank network 108 forwards forward credit amounts (i.e., net tips) for identified debit card accounts to the debit card issuer 110. This step can include forwarding instructions to apply credits equaling gross or net gratuity amounts indicated in tip credits 109 to specified employee debit cards 112. As noted above with reference to FIGS. 1 and 2, the bank network 108 can be an ACH network and step 319 can include forwarding instructions for an ACH credit transfer of a tip (i.e., gratuity) total from the debit card issuer 110 to the debit card 112 associated with an employee.

Next, in response to receiving instructions for tip credits 109, step 322 is performed by the debit card issuer 110 to apply tip credits to employee debit cards 112.

In step 324, the TipQuick server 113 generates and forwards financial reports, such as, but not limited to, overall payroll and compensation reports, to the merchant computing device 204. This step can be performed in response to a request for the financial reports initiated via user interaction with the merchant management interface 254. Examples of the reports generated and forwarded in step 324 are described with reference to FIGS. 5-7 below.

Steps 326 and 327 can be performed periodically to transmit, via the bank network 108, instructions for an ACH debit transfer of a lump sum payment 111 from a financial account associated with the merchant to the debit card issuer 110. The financial account associated with the merchant can be a merchant account issued by a merchant account issuer 210, a line of credit, or a TipQuick transaction account.

FIGS. 4A and 4B depict how a database can be used to map tip disbursements to employees working at multiple locations or merchants 211 to respective debit cards 112. FIGS. 4A and 4B are described with continued reference to the embodiments illustrated in FIGS. 1-3. However, FIGS. 4A and 4B are not limited to those embodiments. In addition to the data flows and sequences described above with reference to FIGS. 1-3, embodiments can manage tip processing in environments where tipped employees work for multiple merchants 211 or at multiple merchant locations.

FIG. 4A shows how a database 252, such as, but not limited to, a relational database, can be used to process tip credits 109 for multiple merchants 211 or merchant locations 211A-N for one or more employee debit cards 112 by mapping the merchants 211 and merchant locations 211A-N to employee debit cards 112A-N. By establishing the many-to-many relationship or mapping 400 shown in FIG. 4A, tips for multiple employees (i.e., employees A-N) that may work at multiple merchants 211 or merchant locations 211A-N. The mapping shown in Figure 4A enables processing of cashless tips in cases where ‘employee B’ works at merchant locations 211A and 211B and has a single employee debit card 112B. For example, if employee B works at two locations of a restaurant chain during a work period (i.e., works shifts for locations 211A and 211B during a given day or week), the database 252 can be used by the TipQuick server 113 to aggregate the tip credits 109 from locations 211A and 211B into a single tip credit 109B. In this way, employee B does not need to be issued multiple debit cards 112 in order to receive tip credits 109 from multiple merchant locations. The database 252 depicted in FIG. 4A enables managers such as GMs, using the merchant management interface 254 at merchant computing devices 204, to create a mapping between multiple merchant locations and employee debit cards 112. By establishing such a many-to-many mapping in the database 252, the tip credits 109A-N can be credited to corresponding employee debit cards 112A-N in environments where employees may work at multiple merchants 211 or multiple merchant locations 211A-N. In this way, the database 252 allows an employee who may work for multiple merchants 211 or at multiple merchant locations 211A-N to receive cashless tips without needing a separate debit card 112 for each merchant 211 (or each merchant location 211A-N).

FIG. 4B depicts how the database 252 can be also used to establish a many-to-one mapping 410 between merchant locations 211A-B and an employee debit card 112A for an employee (e.g., ‘employee A’). As shown, tip credits 109A and 109B stemming from employee A′s work at merchant locations 211A and 211B can be mapped via the database 252 to the employee's debit card 112A. In this way, the database 252 enables a given employee to receive separate tip credits 109A and 109B associated with work at merchant locations 211A and 211B, respectively, without requiring use of multiple debit cards 112. The embodiment shown in FIG. 4B also enables employee A to receive the tip credits 109A and 109B as they are processed by merchant locations 211A and 211B, respectively, so that the merchant locations 211A-B need not coordinate or aggregate their respective tip credits 109A and 109B into a single transaction. For example, if employee A works a lunch shift at merchant location 211A and a dinner shift at merchant location 211B, the many-to-one mapping 410 enables that employee to receive cashless tips as tip credits 109A and 109B when the respective tipping out process occurs at merchant locations 211A and 211B.

### Exemplary Reports and Tip Data

FIGS. 5-8 depict exemplary financial reports and tip data that allow owners and managers to quickly visualize overall hourly rates for various departments and ensure they are within desired levels for a given merchant (i.e., an owner's business and/or a merchant location managed by a GM). The reports shown in FIGS. 5-7 and tip data shown in FIG. 8 can be rendered in a user interface, such as, for example, the merchant management interface 254. For brevity, only the differences occurring within the figures, as compared to previous or subsequent ones of the figures, are described below.

FIG. 5 depicts a monthly wage and tip report 500 that displays wages, tips, and other financial data for a selected month. As shown, the monthly wage and tip report 500 displays, for each employee 502, the employee's department 504, and the employee's wage or salary 506. In some embodiments, the wage or salary 506 can indicate an hourly wage or annual salary. The monthly wage and tip report 500 includes individual monthly totals for each employee's regular hours 508, overtime hours 510, total wages 512, and cashless tips 509, which are labeled as ‘TipQuick tips’ in the exemplary embodiment of FIG. 5. The monthly wage and tip report 500 also displays total cash tips 514 for the selected month along with an indication of the percentage of each employee's total monthly tips that are made up of the cash tips 514. Many merchants and establishments do not know the precise amount of cash tips 514 received. In the exemplary embodiment of FIG. 5, 21.84% is the percentage of income the given establishment/merchant received in the previous year in the form of cash. Assuming tips received at that merchant were paid by customers in the same manner and percentage (i.e., 21.84% of total tips were in the form of cash), then the amounts of cash tips 514 displayed in FIG. 5 represent estimates of the cash tips 514 received. In certain embodiments, cash tips 514 can be estimated based at least in part on what employees tell the merchant. In other embodiments, cash tips 514, including pooled tips, can be reported by the merchant. Regardless of how cash tips 514 are estimated, calculated, or reported, such cash tips 514 are included in the total tips 516 amount in order to determine an accurate effective rate 518. The monthly wage and tip report 500 includes total tips 516, representing a sum of cashless tips 509 and cash tips 514, on a per-employee basis for the selected month. As seen, the monthly wage and tip report 500 also includes an effective rate 518, which includes each employee's total wages 512, which takes into account an hourly rate, multiplied by the number of hours worked (sum of regular hours 508 and overtime hours 510). Total wages 512 plus total tips 516 are then divided by total hours (sum of regular hours 508 and overtime hours 510) in order to determine respective effective rates 518 for all hourly employees, or gross wages in the case of salaried employees. FIG. 5 also illustrates how the monthly wage and tip report 500 displays daily subtotals 520 of tip data as a total value for all employees and on a per-employee basis for each day of the selected month. Lastly, the monthly wage and tip report 500 also includes aggregate monthly totals 522 of cashless tips 509, cash tips 514, and total tips 516 for all employees for the selected month. In cases where a selected month is the current month, the monthly wage and tip report 500 can display the above-described individual monthly totals, aggregate monthly totals 522, and daily subtotals 520 for however many days of the current month that wage and tip data are available.

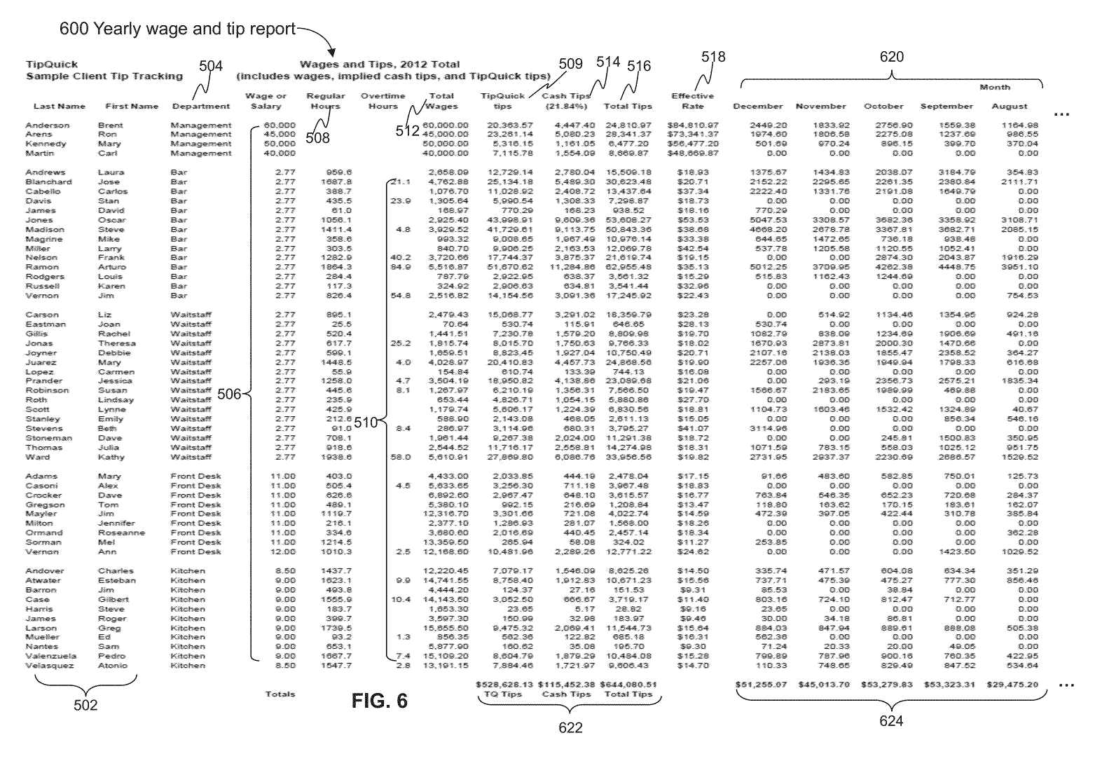

FIG. 6 depicts a yearly wage and tip report 600 that displays total wages and tips for a selected year. As shown, the yearly wage and tip report 600 displays, for each employee 502, yearly totals for each employee's regular hours 508, overtime hours 510, total wages 512, and cashless tips 509, which are labeled as ‘TipQuick tips’ in the exemplary embodiment of FIG. 6. The yearly wage and tip report 600 also displays total cash tips 514 for the selected year along with an indication of the percentage of each employee's total yearly tips that are made up of the cash tips 514. The yearly wage and tip report 600 includes total tips 516, representing a sum of cashless tips 509 and cash tips 514, on a per-employee basis for the selected year. As seen, the yearly wage and tip report 600 also includes an effective rate 518, effective rate 518, which represents each employee's total wages 512 for the selected year, which takes into account an hourly rate, multiplied by the number of hours worked for the year (sum of regular hours 508 and overtime hours 510 for the year). Total wages 512 plus total tips 516 are then divided by total hours for the year (sum of regular hours 508 and overtime hours 510) in order to determine respective effective rates 518 for all hourly employees for the selected year. As shown in FIG. 6 the yearly wage and tip report 600 displays monthly subtotals 620 of tip data as a total value on a per-employee basis for each month of the selected year. The yearly wage and tip report 600 also displays aggregate yearly totals 622 of cashless tips 509, cash tips 514, and total tips 516 for all employees for the selected year. Lastly, the yearly wage and tip report 600 includes aggregate monthly totals 622 of tips for all employees for each month of the selected year. In cases where a selected year is the current year, the yearly wage and tip report 600 can display the above-described individual yearly totals, aggregate yearly totals 622, and monthly subtotals 620 for however many months of the current year that wage and tip data is available for.

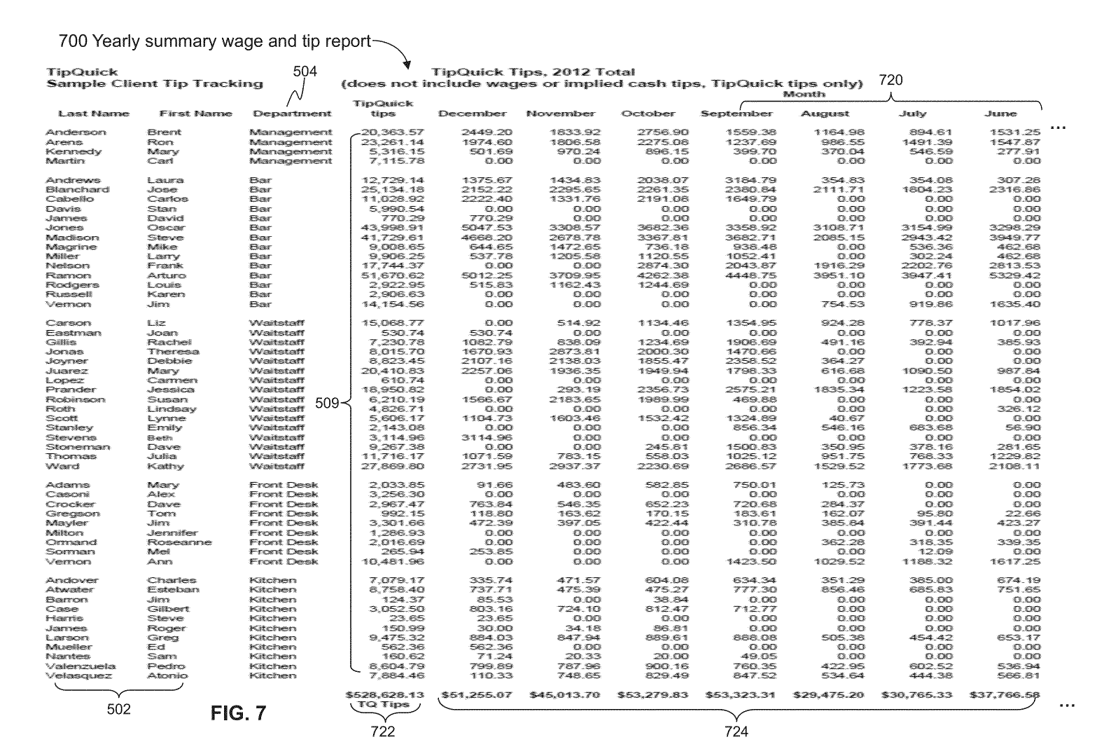

FIG. 7 illustrates a yearly summary tip report 700. As shown, the yearly summary tip report 700 displays, for each employee 502, yearly totals for each employee's cashless tips 509, which are labeled as ‘TipQuick tips’ in the exemplary embodiment of FIG. 7. The yearly summary wage and tip report 700 includes monthly subtotals 720 of cashless tips 509 on a per-employee basis for each month of the selected year. The yearly summary wage and tip report 700 also includes aggregate yearly totals 722 of cashless tips 509 for all employees for the selected year. The yearly summary wage and tip report 700 additionally includes aggregate monthly totals 724 of cashless tips 509 for all employees for each month of the selected year. When the selected year is the current year, the yearly summary wage and tip report 700 can display the above-described individual yearly totals, aggregate yearly totals 722, aggregate monthly totals 724, and monthly subtotals 720 for however many months of the current year that cashless tip data is available for.

FIG. 8 depicts an exemplary submission of tip data 105 from a merchant 211 to the TipQuick server 113, according to an exemplary embodiment. In one embodiment, the tip data 105 shown in FIG. 8 is sent from the merchant 211 to the TipQuick server 113 after being collected or input at the merchant computing device 204. The tip data 105 shown in FIG. 8 for various employee IDs 205 can be sent to the TipQuick server 113 as input. As shown, the tip data 105 can also be presented in a report 800 that depicts tip data 105 for each employee ID 205 for a given work period or shift 805. FIG. 8 depicts how the tip data 105 can include final, total tips for the shift 805 for individual employee IDs 205. The total tips can be summed to calculate the employee category totals 816 shown in FIG. 8. As seen in FIG. 8, the employee category totals 816 can in turn be summed to calculate a final tip total 822 for the shift 805. In the exemplary embodiment of FIG. 8, the final tip total 822 represents total gross tips prior to any deductions, withholdings, or garnishments, which can be calculated by the TipQuick server 113 upon receipt of the tip data 105. The total tips for each employee may be adjusted, for example, by deducting a proportional amount of the credit card rate 818, which represents the amount of a credit card discount rate the merchant 211 pays to a credit card company to process the total tips for each employee.

The above-described reports are helpful in environments where ‘customer facing’ employees 502 in certain departments 504, such as, for example, servers and bartenders, split a portion of their gratuities with other staff such as, for example, barbacks, bussers, hostesses, and other employees 502. For example, the reports shown in FIGS. 5-8 allow an owner or manger to quickly determine if an hourly wage for a given employee 502 needs to be adjusted in light of cashless tips 509, pooled/shared tips, and cash tips 514. According to this example, a restaurant manager or GM can determine that an hourly wage paid to employees 502 in certain departments 504, such as barbacks in the ‘Bar’ department, can be reduced based on an effective rate 518 being higher than expected or budgeted for a barback position. The reports allow owners and managers to selectively reduce an hourly wage or salary 506 for certain tipped employees 502 as compared to other employees 502, such as kitchen staff who are not receiving cashless tips 509 or cash tips 514, so that the effective compensation for the tipped employees 502 is comparable to other employees 502 who are not receiving gratuities. By using the exemplary reports shown in FIGS. 5-8, owners and managers can quickly determine, based on the portion of tips certain employees 502 (i.e., barbacks in the Bar department 504) are making, whether the employees 502 are being paid more (or less) than expected or budgeted for their position or department 504. Because the reports enable owners and managers to quickly visualize total effective rates 518 based on salaries 506, wages 512, overtime hours 510, cashless tips 509 and cash tips 514, the owners and managers can selectively adjust hourly wages 512 or salaries 506 for certain employees 502 while keeping the employees' total compensation within a desired range.

The example reports illustrated in FIGS. 5-8 depict how some employees 502, such as bussers and food runners in the ‘Kitchen’ department 504 do not get the same amount of tips as other employees 502. These financial reports can indicate that employees 502 receiving less tip compensation may only be used during extremely busy shifts. The reports allow owners and manager to quickly determine this and potentially adjust (i.e., increase/raise) the wage or salary 506 of the employees 502 receiving relatively low tip compensation so that they fall into a desired compensation range for their positions and/or departments 504. The amounts in the monthly/yearly reports shown in FIGS. 5-8 can also enable merchants and owners to ensure and demonstrate that wages conform with mandated minimum wage and other regulatory requirements. For example, the reports can enable an establishment to demonstrate how, in cases where tipped employees' base wages are going to be held static, that these employees are actually earning more than a mandated, regulated minimum wage through a combination of hourly earnings and tips.

According to embodiments, reports shown in FIGS. 5-8 can be provided for multiple merchants 211 and/or multiple merchant locations. By analyzing financial data included in the reports with other establishments, owners and managers can determine if their payroll and compensation for employees 502 is in line with that of comparable merchants. For example, data shown in FIGS. 5-8 can be sorted, aggregated and summarized in order to perform comparisons with other merchants or merchant locations to identify norms and averages per department 504 (i.e., management, kitchen, bar, waitstaff, front desk), employee category (i.e., server, bartender, barback, busser, food runner), merchant type (i.e., bar, restaurant, salon, spa, hotel, car service), shift 805, and geographic region or city. Such comparisons to norms or averages can be based in part on financial data pulled from various TipQuick servers 113 and/or industry surveys, such as, for example, restaurant association surveys and lodging industry surveys.

The financial analysis and management reports shown in FIGS. 5-7 enable owners and managers to quickly ascertain their employees' effective rates 518 and be aware of the total tips 516 included in the effective rates 518. In this way, the reports shown in FIGS. 5-7 provide owners and managers with ‘tip awareness’ to know how much tips are supplementing employee compensation. The financial reports also provide merchants with tip accountability by helping ensure that tips, including cash tips 514, are accounted for and not diverted.

### Exemplary Method

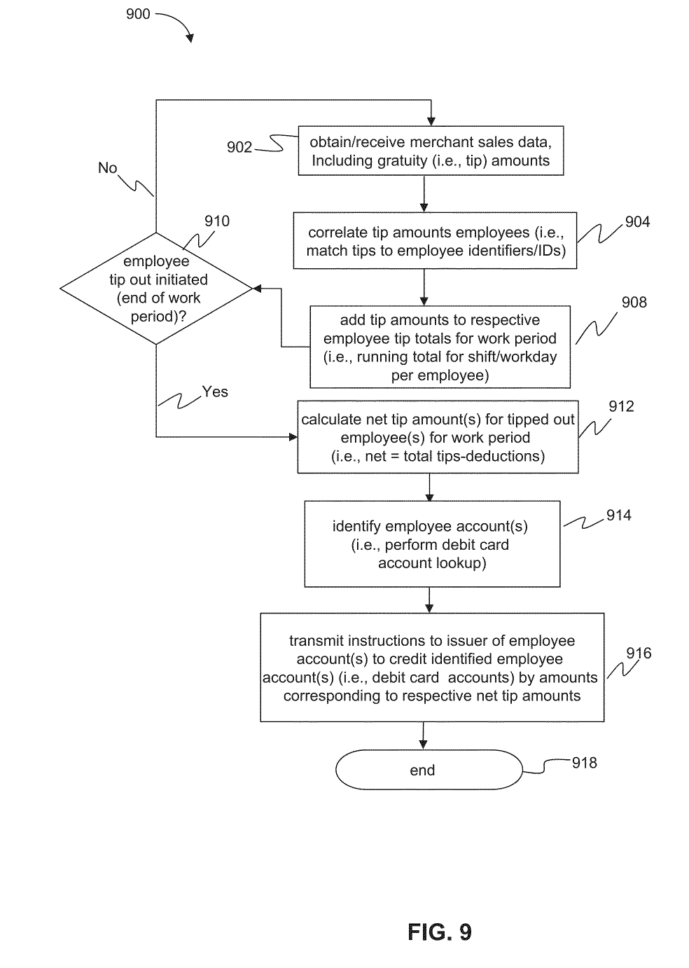

Embodiments may include one or more methods of managing gratuity disbursement. In this regard, referring to FIG. 9, there is a flow chart illustrating an exemplary method 900 for processing and managing cashless tips. For illustrative purposes, the method 900 is described with reference to the system and architecture implementations depicted in FIGS. 1 and 2 and the communication sequence depicted in FIG. 3. Other implementations, however, are possible. The steps of the method 900 do not necessarily have to occur in the order shown in FIG. 9 and described below. According to embodiments, some of the steps shown in FIG. 9 are optional.

Beginning with step 902, the method 900 receives merchant sales data indicating tip amounts. Step 902 can comprise receiving tip data 105 for a plurality of purchases 103 from a merchant 211. For example, this step can comprise receiving tip data 105 from a merchant computing device 204. In an additional or alternative embodiment, step 902 can comprise receiving tip data 105 from a POS terminal. This step can further comprise receiving employee and configuration data 258. After the tip amounts are received, control is passed to step 904.

In step 904, the tip amounts received in step 902 are correlated to employees. As shown in FIG. 9, step 904 can comprise matching tips to employees based on employee identifiers/IDs. For example, step 904 can comprise matching tip amounts to employee IDs 205. After the tip amounts are correlated to employees, control is passed to step 908.

Next, in step 908, the correlated tip amounts from step 904 are added to respective employee tip totals for a given work period. In the exemplary embodiment provided in FIG. 9, step 908 can be performed to calculate a running total of tips for a shift 805 or a workday per employee. After the employee tip totals are calculated, control is passed to step 910.

In step 910, a determination is made as to whether an employee tip out has been initiated or not. This step can comprise determining if a tipping out process has been initiated due to the end of a shift or work period being reached. If it is determined that an employee tip out has not been initiated, control is passed back to step 902. As seen in FIG. 9, steps 902-910 can be repeated until a tipping out process has started. Otherwise, if it is determined that a tipping out process has been initiated, control is passed to step 912.

In step 912, net tip amounts are calculated for tipped out employees for a given work period or shift. As shown, this step can comprise calculating net tips by subtracting any deductions, withholdings, or garnishments from gross tip amounts. Step 912 can be performed if the employee and configuration data 258 indicate that an employee's tips are subject to any withholdings, such as mandatory medical care withholdings. If an employee's tips are not subject to any deductions, withholdings, or garnishments, step 912 need not be performed. After the net tip amount is calculated, control is passed to step 914.

Next, in step 914, employee financial accounts for any tipped out employees are identified. As illustrated in FIG. 9, this step can comprise performing a debit card account lookup. For example, step 914 can be performed by looking up account numbers for employee debit cards 112. This lookup can be performed using the database 252 described above with reference to FIGS. 2, 4A and 4B. After the employee financial accounts are identified, control is passed to step 916

In step 916, instructions are transmitted to an issuer of the employee accounts identified in step 914 to credit the identified employee accounts by amounts corresponding to respective net tip amounts. As shown, step 916 can comprise transmitting instructions to credit debit card accounts for tipped out employees. The amounts indicated in the instructions transmitted in step 916 correspond to the net tip amounts calculated in step 912. For example, step 916 can be performed by sending tip credits 109 to a debit card issuer 110 for employee debit cards 112. After the instructions are transmitted, control is passed to step 918 where method 900 ends.

While embodiments detailed herein have been directed towards systems and methods for disbursement of cashless gratuities via credits to financial accounts, other embodiments may be used in association with disbursement of cash gratuities, including environments where tips are received with non-cash and cash payments to a merchant. For example, the systems and methods disclosed herein can be used to manage disbursement of gratuities to tipped staff and employees in cases where payments for goods and/or services are made by customers using one or more non-cash instruments (i.e., credit, debit, and/or gift cards), and gratuities for such sales are paid, partially or wholly, in cash. Similarly, the exemplary systems and methods detailed herein can be used to process and manage disbursement of gratuities for merchants receiving portions of sales payments (including gratuities) in cash and portions via non-cash instruments.

Exemplary Computer System Implementation

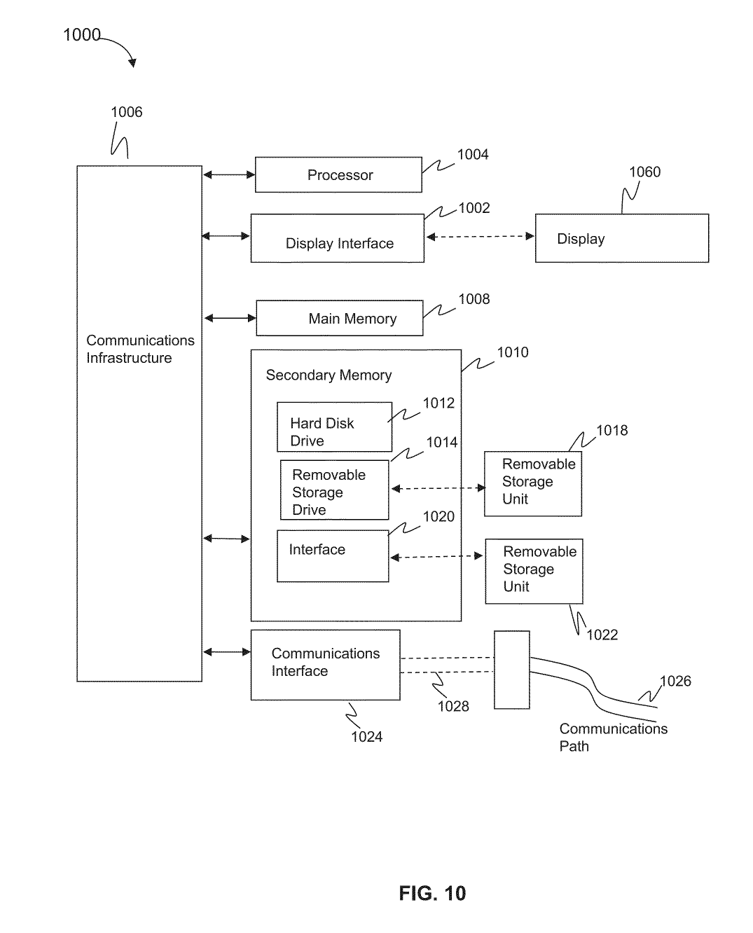

Although exemplary embodiments have been described in terms of systems and methods, it is contemplated that certain functionality described herein may be implemented in software on microprocessors, such as a microprocessor chip included in computing devices such as the computing devices 104, 106 and 204 shown in FIGS. 1 and 2 and the computer system 1000 illustrated in FIG. 10. In various embodiments, one or more of the functions of the various components may be implemented in software that controls a computing device, such as the computer system 1000, which is described below with reference to FIG. 10.

Aspects of the present invention shown in FIGS. 1-9, or any part(s) or function(s) thereof, may be implemented using hardware, software modules, firmware, tangible computer readable media having logic or instructions stored thereon, or a combination thereof and may be implemented in one or more computer systems or other processing systems.

FIG. 10 illustrates an example computer system 1000 in which embodiments of the present invention, or portions thereof, may be implemented as computer-readable instructions or code. For example, some functionality performed by the computing devices 104, 106 and 204 and their respective modules shown in FIG. 1, can be implemented in the computer system 1000 using hardware, software, firmware, non-transitory computer readable media having instructions stored thereon, or a combination thereof and may be implemented in one or more computer systems or other processing systems. Hardware, software, or any combination of such may embody certain modules and components used to implement steps in the method 900 illustrated by the flowchart of FIG. 9 discussed above. Similarly, hardware, software, or any combination of such may embody the system 100 and architecture 200 components discussed above with reference to FIGS. 1 and 2.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 1000. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. As will be appreciated by persons skilled in the relevant art, processor device 1004 may also be a single processor in a multi-core/multiprocessor system, such system operating alone, or in a cluster of computing devices operating in a cluster or server farm. Processor device 1004 is connected to a communication infrastructure 1006, for example, a bus, message queue, network, or multi-core message-passing scheme. In certain embodiments, one or more of processors of the computing devices 104, 106 and 204 described above with reference to FIGS. 1 and 2 can be embodied as the processor device 1004 shown in FIG. 10.

The computer system 1000 also includes a main memory 1008, for example, random access memory (RAM), and may also include a secondary memory 1010. The secondary memory 1010 may include, for example, a hard disk drive 1012, removable storage drive 1014. The removable storage drive 1014 may comprise a floppy disk drive, a magnetic tape drive, an optical disk drive, a flash memory, or the like. In non-limiting embodiments, one or more memories of the computing devices 104, 106 and 204 described above with reference to FIGS. 1 and 2 can be embodied as the main memory 1008 shown in FIG. 10.

The removable storage drive 1014 reads from and/or writes to a removable storage unit 1018 in a well known manner. Removable storage unit 1018 may comprise a floppy disk, magnetic tape, optical disk, etc. which is read by and written to by removable storage drive 1014. As will be appreciated by persons skilled in the relevant art, removable storage unit 1018 includes a non-transitory computer readable storage medium having stored therein computer software and/or data.

In alternative implementations, secondary memory 1010 may include other similar means for allowing computer programs or other instructions to be loaded into the computer system 1000. Such means may include, for example, a removable storage unit 1022 and an interface 1020. Examples of such means may include a program cartridge and cartridge interface (such as that found in video game devices), a removable memory chip (such as an EPROM, or EEPROM) and associated socket, and other removable storage units 1022 and interfaces 1020 which allow software and data to be transferred from the removable storage unit 1022 to the computer system 1000. In non-limiting embodiments, one or more of the memories described above with reference to the computing devices 104, 106 and 204 of FIGS. 1 and 2 can be embodied as the main memory 1008 shown in FIG. 10. In some embodiments, the database 252 depicted in FIGS. 2, 4A and 4B can be stored in the main memory 1008 or the secondary memory 1010.

The computer system 1000 may also include a communications interface 1024. The communications interface 1024 allows software and data to be transferred between the computer system 1000 and external devices. The communications interface 1024 may include a modem, a network interface (such as an Ethernet card), a communications port, a PCMCIA slot and card, or the like. Software and data transferred via communications interface 1024 may be in the form of signals, which may be electronic, electromagnetic, optical, or other signals capable of being received by communications interface 1024. These signals may be provided to communications interface 1024 via a communications path 1026. The communications path 1026 carries signals and may be implemented using wire or cable, fiber optics, a phone line, a cellular phone link, an RF link or other communications channels.

As used herein the terms “computer readable medium” and “non-transitory computer readable medium” are used to generally refer to media such as memories, such as main memory 1008 and secondary memory 1010, which can be memory semiconductors (e.g., DRAMs, etc.). Computer readable medium and non-transitory computer readable medium can also refer to the removable storage unit 1018, the removable storage unit 1022, and a hard disk installed in the hard disk drive 1012. Signals carried over communications path 1026 can also embody the logic described herein. These computer program products are means for providing software to the computer system 1000.

Computer programs (also called computer control logic) are stored in the main memory 1008 and/or the secondary memory 1010. Computer programs may also be received via communications interface 1024. Such computer programs, when executed, enable computer system 1000 to implement the present invention as discussed herein. In particular, the computer programs, when executed, enable the processor device 1004 to implement the processes of the present invention, such as the steps in the method 900 illustrated by the flowchart of FIG. 9, discussed above. Accordingly, such computer programs represent controllers of the computer system 1000. Where the invention is implemented using software, the software may be stored in a computer program product and loaded into the computer system 1000 using the removable storage drive 1014, the interface 1020, and the hard disk drive 1012, or the communications interface 1024.

In an embodiment, the merchant management/GM interface 254 used to display interfaces and reports on the merchant computing device 204, may be a computer display 1030 shown in FIG. 10. The computer display 1030 of the computer system 1000 can be implemented as a touch sensitive display (i.e., a touch screen) of a POS terminal 104. Similarly, the merchant management/GM interface 254 shown in FIG. 2 may be embodied as a display interface 1002 shown in FIG. 10. Also, the reports and input data shown in FIGS. 5-8 may be rendered on the computer display 1030 via the display interface 1002.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### General Considerations

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing device memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing device from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the steps presented in the examples above can be varied—for example, steps can be re-ordered, combined, and/or broken into sub-steps. Certain steps or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A computer-implemented method for processing gratuity disbursement, the method comprising:
receiving, at a computing device, data corresponding to one or more sales transactions at a merchant, the data including, for each of the one or more sales transactions:
a gratuity amount; and
an indication of an employee associated with the gratuity amount;
calculating, by the computing device, a gratuity total for the employee as a sum of each gratuity amount associated with the employee; and
transmitting instructions to credit a financial account associated with the employee by an amount equaling the gratuity total.

2. The method of claim 1, wherein:
the transmitting comprises transmitting the instructions to an issuer of the financial account associated with the employee, the method further comprising:
transferring funds from a financial account associated with the merchant to the issuer.

3. The method of claim 2, wherein:
the financial account associated with the merchant is one or more of a merchant account, a transaction account, or a line of credit; and
the funds are periodically transferred based at least in part on a cumulative total of a plurality of credits from the issuer to the financial account associated with the employee processed by the issuer over a defined period.

4. The method of claim 2, wherein:
the financial account associated with the employee is a debit card account; and
the issuer is a financial institution; and
the transmitting comprises transmitting the instructions via a financial network.

5. The method of claim 4, wherein the financial institution is one of a bank, a credit union, and a savings and loan (S&L) association.

6. The method of claim 2, wherein:
the transmitting comprises transmitting, via an Automated Clearing House (ACH) network, instructions for an ACH credit transfer of the gratuity total from the issuer to the financial account associated with the employee; and
the transferring comprises transmitting, via the ACH network, instructions for an ACH debit transfer of the funds from the financial account associated with the merchant to the issuer.

7. The method of claim 1, wherein:
the data further includes, for each of the one or more sales transactions:
a timestamp indicating a date and time of a sale; and
a merchant identifier uniquely identifying a merchant establishment; and
the calculating comprises calculating, based at least in part upon timestamps and merchant identifiers in the data, the gratuity total for the employee as a sum of each gratuity amount associated with the employee for one or more defined periods at one or more merchant establishments.

8. The method of claim 7, wherein:
the merchant identifier indicates a merchant location; and
the one or more defined periods are one or more of a week, a day, and a shift worked by the employee at one or more merchant locations.

9. The method of claim 1, wherein:
the calculating comprises calculating a net gratuity for the employee by subtracting deductions for one or more of taxes, garnishments, benefits, reimbursements, processing fees, and other withholdings from the gratuity total; and
the transmitting comprises transmitting instructions to credit the financial account associated with the employee by an amount equaling the net gratuity.

10. The method of claim 1, wherein the receiving comprises receiving the data from one or more point-of-sale (POS) terminals at locations of the merchant.

11. The method of claim 1, wherein the receiving comprises receiving the data from a POS system associated with the merchant.

12. The method of claim 1, wherein the data corresponds to a plurality of sales transactions at a plurality of merchant establishments, and wherein the data further includes, for each of the plurality of sales transactions:
a timestamp indicating a date and time of the sale;
an employee identifier uniquely identifying an employee associated with the gratuity amount; and
a merchant identifier uniquely identifying one of the plurality of merchant establishments, the method further comprising:
retrieving wage data for a plurality of employees of the plurality of merchant establishments;
correlating, based on employee identifiers in the data, each of the plurality of employees with respective gratuity amounts in the data;
determining, based at least in part upon the wage data, the merchant identifiers, and the gratuity amounts associated with respective ones of the plurality of employees, overall compensation for each of the plurality of employees and payroll for each of the plurality of merchant establishments; and
generating financial reports indicating the overall compensation for each of the plurality of employees and the payroll for each of the plurality of merchant establishments.

13. The method of claim 12, further comprising:
calculating average overall compensation for identified employee categories based on the overall compensation for each of the plurality of employees;
comparing average overall compensation for the identified categories of employees to retrieved overall compensation averages for similar categories of employees at other merchants; and
producing, based on the comparing, management reports indicating comparisons of the merchant's overall compensation averages for the employee categories with the overall compensation averages for similar categories of employees at other merchants.

14. The method of claim 12, further comprising:
calculating average payroll for identified establishment types and locations based on the payroll for each of the plurality of merchant establishments;
comparing average payroll for the identified establishment types and locations to retrieved payroll averages for other merchants having similar establishment types and locations; and
producing, based on the comparing, management reports indicating comparisons of the merchant's payroll averages for the establishment types and locations with the payroll averages for other merchants having similar establishment types and locations.

15. A system comprising:
a processor; and
a memory having instructions stored thereon that, if executed by the processor, cause the processor to perform operations for managing gratuity disbursement, the operations comprising:
receiving data corresponding to one or more sales transactions at a merchant, the data including, for each of the one or more sales transactions:
a gratuity amount; and
an indication of an employee associated with the gratuity amount;
calculating a gratuity total for the employee as a sum of each gratuity amount associated with the employee; and
transmitting instructions to credit a financial account associated with the employee by an amount equaling the gratuity total.

16. The system of claim 15, wherein:
the data further includes, for each of the plurality of sales transactions:
a timestamp; and
a merchant location identifier; and
the calculating comprises calculating the gratuity total for the employee as a sum of each gratuity amount associated with the employee for a defined period and a merchant location based at least in part upon timestamps and merchant location identifiers in the data.

17. The system of claim 15, further comprising a display device, the operations further comprising:
retrieving wage data for a plurality of employees of the merchant;
correlating each of the plurality of employees with respective gratuity amounts included in the data;
calculating overall payroll and compensation for each of the plurality of employees for each of the merchant locations; and
generating one or more reports based indicating the overall compensation for each of the plurality of employees and the payroll for each of the one or more merchant locations; and
rendering, on the display device, the one or more reports.

18. A non-transitory computer readable storage medium having program instructions stored thereon for processing gratuity disbursements, the instructions being executable by a processor of a computing device, the instructions comprising:
instructions for receiving data corresponding to one or more sales transactions at one or more merchant locations, the data including, for each of the one or more sales transactions:
a gratuity amount; and
an indication of a staff member associated with the gratuity amount;
instructions for calculating a gratuity total for the staff member as a sum of each gratuity amount associated with the staff member; and
instructions for transmitting a request to credit a financial account associated with the staff member by an amount equaling the gratuity total.

19. The computer readable storage medium of claim 18, wherein the financial account associated with the staff member is a debit card account at an issuer of a debit card assigned to the staff member, the instructions further comprising:
instructions for periodically transferring funds from a financial account associated with a merchant to the issuer based on a cumulative total of a plurality of credits from the issuer to the debit card over a defined period.

20. The computer readable storage medium of claim 19, wherein the defined period is one or more of a month, a payroll period of the merchant, a week, and a day.
